(19) United States
(12) Patent Application Publication
(10) Pub. No.: US 2004/0076306 A1
(43) Pub. Date: Apr. 22, 2004

(54) Surround sound effect earphone

(76) Inventor: Chih-Hao Edmund Pan, Taipei (TW)

Correspondence Address: RABIN & BERDO, P.C., Suite 500, 1101 14th Street, N.W., Washington, DC, 20005, US

(21) Appl. No.: 10/271,778

(22) Filed: Oct. 17, 2002

(51) Int. Cl. H04R 25/00

(52) U.S. Cl. 381/370; 381/371; 381/374; 381/376

(57) ABSTRACT

A surround sound effect earphone, particularly an earphone structure that is designed for listening to modern music or films with multiple channel surround sound effects, in addition to conventional two-way channel music, comprising a front speaker and a rear speaker installed respectively at a front side and a rear side inside a left ear hood and a right ear hood of a headband earphone. The front and rear speakers are respectively connected with independent signal cords, which are then collected and connected to the earphone connector. The ear hood unit is optionally divided to include two units to accommodate the front and rear speakers, which can be turned outward or folded together. Or the front and rear speakers can be fixed on the ear hood units that are joined together, and by moving the positions of the ear hood units the user can change the distance between the front and the rear speakers. Or the front and rear speakers can be installed and fixed to the ear hood unit frame, so a detachable and combinable slide cover structure is installed in the ear hood unit covering the rear speaker. In such a structure, when the invention is worn, the user's ears are located between the front and the rear speakers. To listen to music or watch a film, especially a music piece or a film with surround sound effects, the user can use the design of the invention of front and rear speakers, to enjoy the loyal reproduction of music. Or, by adjusting the relative positions of the front and rear speakers, or replacing the ear hood cover unit, the user can obtain enhanced sound effects.

### BACKGROUND OF THE INVENTION

(a) Field of the invention The invention relates to a surround sound effect earphone, comprising a front and a rear speaker respectively installed at a front and a rear side inside a left and a right ear hood unit in a headband earphone. The front and rear speakers are respectively connected with independent signal cords that are collected and connected to the earphone connector. The ear hood units for fixing the front and rear speakers may be overturned, folded, moved, or have their cover unit replaced. Thereby, when the user is wearing the earphone and listening to a music piece or a film, the front and rear speakers located at the front and rear of the user's ears will reproduce the surround sound effects of the music, to obtain surround effects that could not be found in conventional earphones. Furthermore, by adjusting the ear hood units or changing the ear hood cover unit, the user can change the angles or positions of the front and rear speakers, providing more resourceful reproduction of the original sound effects.

(b) Description of the Prior Art

Two-way channel sound is the mainstream of conventional music or film sound effects. Therefore, earphone products for conventional sound effects are made to include a speaker on the right and another speaker on the left to comprise a stereo earphone. There are various types of structure and design of conventional stereo earphones on the market, including headband type, hang-on-ear type, earplug type, or corded or cordless type. However, the conventional two-way channel stereo sound has been replaced by multiple channel surround sound effects. All types and specifications of recording technology are competing on the market. Audio-visual equipment has developed from 5.1 channels, 6.1 channels to 7.1 channels to suit the requirements of various multiple channel recording specifications; general users can satisfy their personal interests and actual requirements by constructing a simple two-channel pure acoustic system (i.e. a Hi-End system), or construct a family theater to satisfy the whole family's enjoyment of multiple channel audio-visual facilities and systems. As for acoustic facilities and appliances, there are appropriate machines and facilities to suit various specifications of two or three channels. However, the supply of earphone appliances still remain at the stage of two-way stereo sound on the conventional left and right speakers. There will be no problem when such conventional earphone is used to listen to the ordinary sound effects of two-way stereo music recording. But when it comes to listening to modern specifications of multiple channel recording (especially all types of films), the user is limited to the use of only a left and a right speaker to listen to two-way stereo sound effect. Then, the sense of movement and 3D surround sound effects could not be reproduced. That leaves much room for improvement.

In view of the shortcomings of conventional type of earphone products that can only provide two-way sound, the inventor has used his rich experience in the research, development and production of video-visual products for many years and dedicated in the research for improvement and has finally developed a type of product, after repeated conceptions, drawings, test production, tests, revisions, involving a front and a rear speaker at the front and rear inside an ear hood unit, so that when the earphone is worn, the front and rear speakers are squarely located at the front and rear of the user's ears, so that, besides listening to ordinary two-channel recording, the invention is capable of listening to the multiple channel recording and reproducing the original surround sound effects in the user's ears, and by adjusting the ear hood unit or replacing the ear hood cover unit, and changing the angles and positions of the front and rear speakers, and the resonance properties, the invention is capable of reproducing multiple sound effects.

For better understanding of the characteristics and technical contents of the present invention, please refer to the following description and drawings.

### BRIEF DESCRIPTION OF DRAWINGS

FIG. 1 is a perspective view of the present invention.

FIG. 2 is a top section view of the invention when it is worn.

FIG. 3 is a view of the invention with its front and rear hood units turned outwardly.

FIG. 4 is an embodiment view of the present invention wherein the ear hood unit is designed to include a front and a rear hood unit that are joined together.

FIG. 5 is an embodiment view of the present invention wherein the ear hood unit is designed to include a front and a rear hood unit, while the rear hood unit slides to the rear.

FIG. 6 is an embodiment view of the present invention wherein the ear hood has a slide cover.

FIG. 7 is a view of the present invention wherein the ear hood has a slide cover, and the slide cover is separated from the ear hood unit.

### BRIEF DESCRIPTION OF NUMERALS

| | |
|---|---|
| 10 | ear hood unit |
| 11 | front hood unit |
| 12 | rear hood unit |
| 13 | support |
| 14 | headband |
| 15 | front hood unit |
| 16 | rear hood unit |
| 17 | fastening hole |
| 18 | through hole |
| 20 | front speaker |
| 21 | signal cord |
| 30 | rear speaker |
| 31 | signal cord |
| 40 | ear |
| 50 | slide cover |
| 51 | protruded fastener |
| 52 | through hole |

### DETAILED DESCRIPTION OF PREFERRED EMBODIMENTS

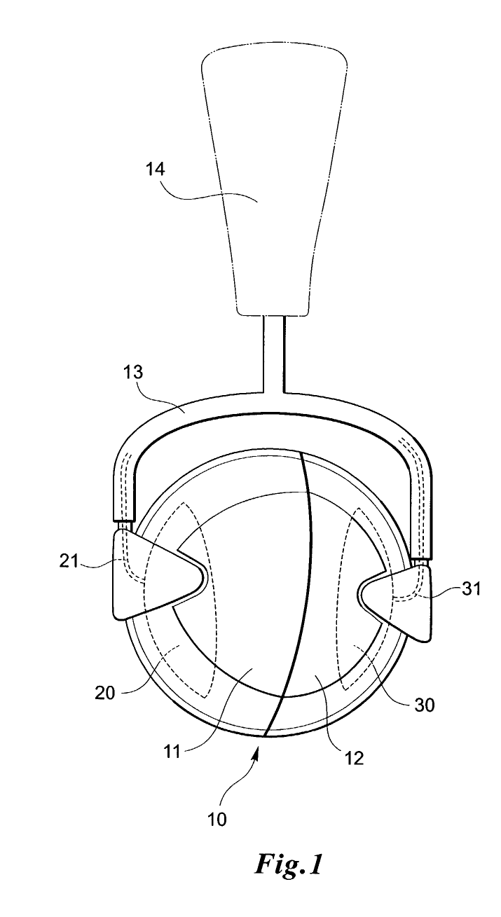

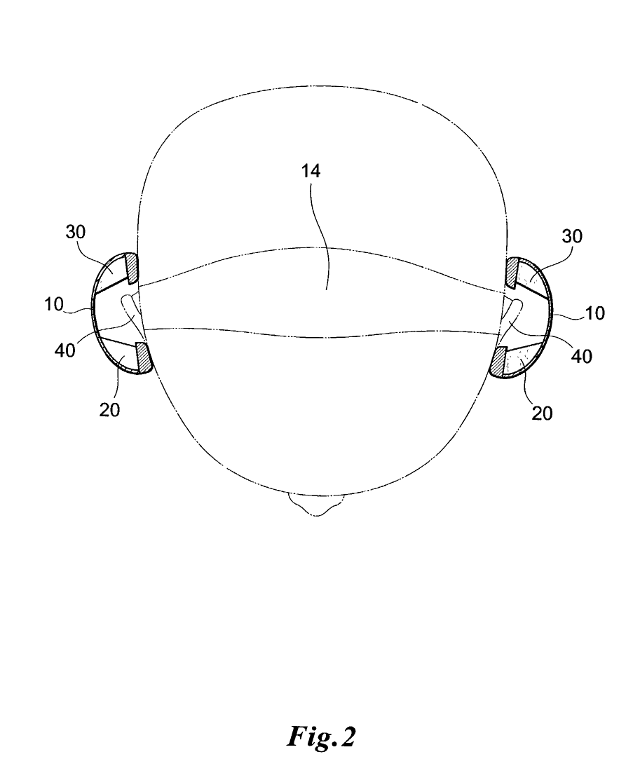

Please refer to FIG. 1, the present invention can be applied to a headband earphone, comprising a front speaker 20 and a rear speaker 30 at a front and a rear side inside left and right ear hood unit 10 of the earphone, the front an drear speakers 20, 30 are respectively connected to signal cords 21, 31, then they are collectively connected to the connector of the earphone. Inside the hollow of the ear hood unit 10, there is an appropriate space reserved between the front and the rear speakers 20, 30. When the invention of earphone is worn on a user's head, the ear hood unit 10 covering the user's ears 40, as shown in FIG. 2, the front and rear speakers 20, 30 are positioned at the front and rear of the ears 40, forming a configuration of two front channels on left and right, and two rear surround channels on left and right. At this time, there is no pressure applied on the ears 40 because they are located within a space formed by the front and rear speakers 20, 30. When the user wishes to listen to conventional two-way sound effect music, the front and rear speakers 20, 30 in the same ear hood unit 10 emit a sound effect of a same sound channel through multiple speakers, giving more light-hearted, harmonized sound and upgraded quality effects. When the user wants to listen to or watch modern multiple-channel music or films, this invention is capable of providing three-dimensional sound effects using its well designed front channels on left and right and rear channels on left and right, thereby its four speakers will perform their maximum effects, and enable more fun when the user is listening to multiple channels of music and films with earphones.

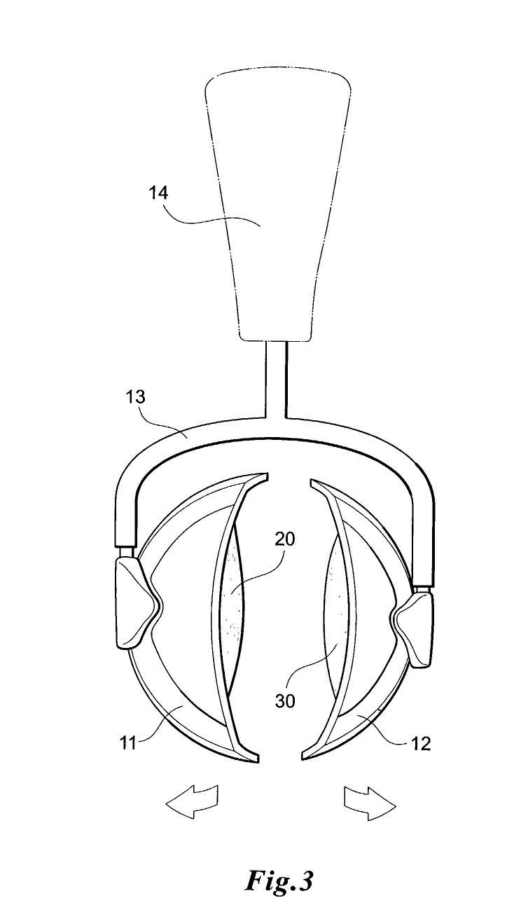

The structural configurations of the ear hood unit 10 of the front and rear speakers 20, 30 can be varied to suit different circumstances and feelings. As shown in FIGS. 1 and 3, the ear hood unit 10 is divided into a front hood unit 11 and a rear hood unit 12 that are separate and combinable. Of which, the front hood unit 11 serves to fasten the front speaker 20, the rear hood unit 12 serves to fasten the rear speaker 30. The front and rear hood units 11, 12 are respectively joined to a front and rear parts of a support 13, the support 13 being connected to a headband 14 of the earphone. In such a structure, the front hood unit 11 and the rear hood unit 12 can be overturned using their joint as a spindle. The front and rear hood units 11, 12 can be folded together as shown in FIG. 1, or they can be turned outwardly to change the relative distance between the front and the rear speakers 20, 30 (and their relative distance from the ears 40). Under this condition, there will be an opening between the front and rear hood units 11, 12 allowing leaking out of partial sound through the opening. Thereby, the user can not only change audio feelings of the ears 40 listening to sound effects from the front or the rear, but can also effectively reduce the feeling of powerful pressure coming from surround sound effects (there are sometimes very big noises coming from a surround sound effect disc, such as roaring airplane or canon balls), to enjoy better comfort.

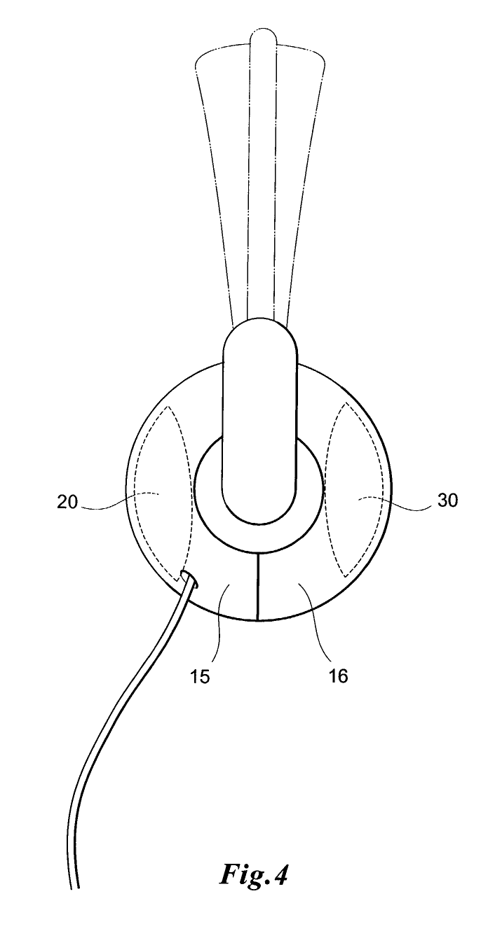

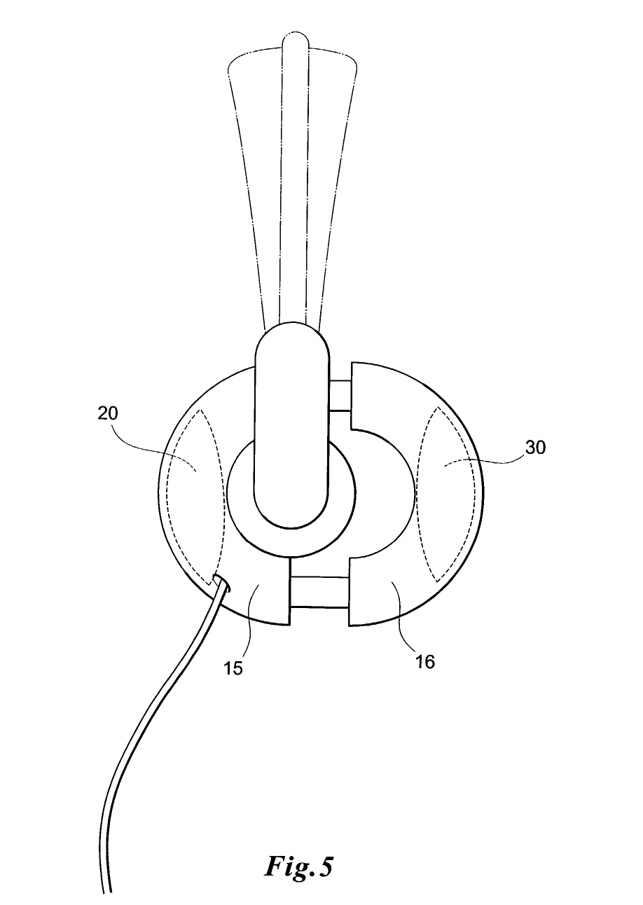

As shown in FIGS. 4 and 5, the invention of ear hood unit can also be designed in two separate units, including a front hood unit 15 that is fixed, and a rear hood unit 16 that is capable of sliding movement in relation to the front hood unit 15. Wherein, the front hood unit 15 serves to accommodate a speaker 20, while the rear hood unit 16 serves to accommodate a rear speaker 30. Likewise, by the installation of the rear hood unit 16 that is capable of sliding movement, the user can adjust the distance between the front and rear speakers 20, 30 to obtain varied feelings of the ears 40 (especially from the feeling of remote sound coming from the rear channel), forming an opening between the front and rear hood units 15, 16 to allow leaking out of powerful sound pressure for better listening comfort.

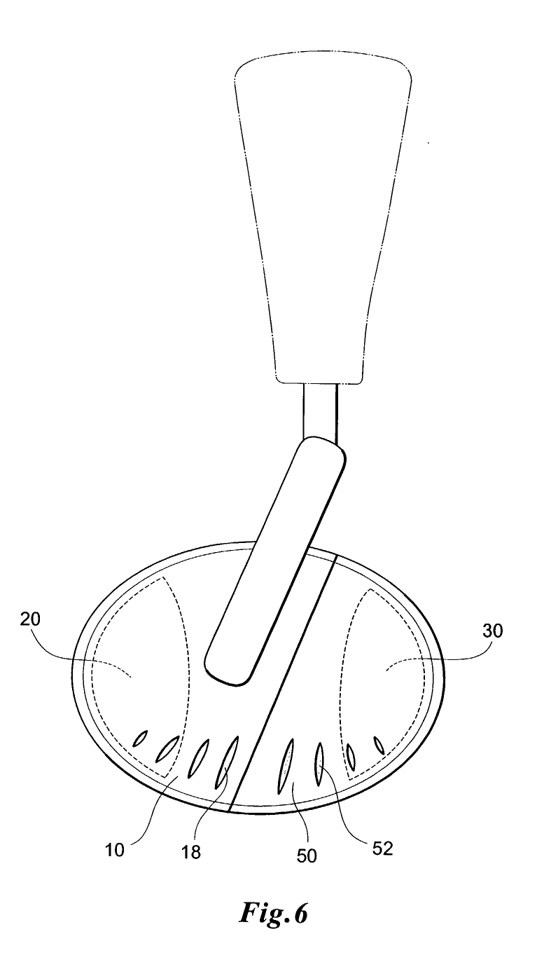

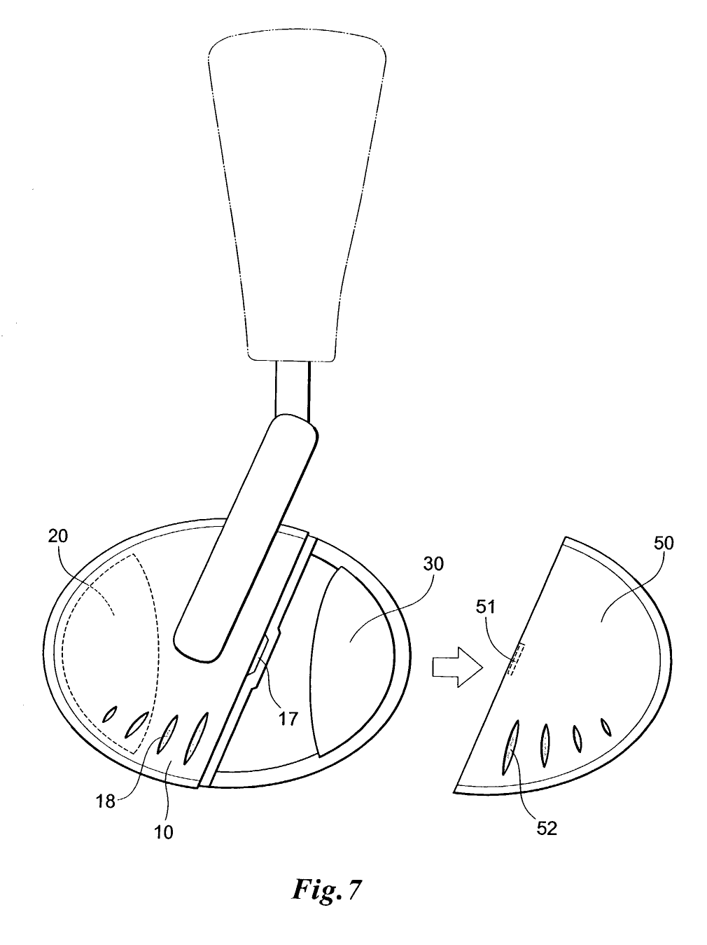

Furthermore, as shown in FIGS. 6 and 7, the present invention of ear hood unit 10 is optionally designed to include a detachable and combinable slide cover 50 in a range of the rear speaker 30 covered by the hood unit. Wherein, the front speaker 20 is installed at the front of the ear hood unit 10, the rear speaker 30 is installed at the rear of the ear hood unit 10, and the slide cover 50 and the ear hood unit 10 can slide and move on tracks in relation to each other, and fastened by a protruded fastener 51 and a fastening hole 17, and on the ear hood unit 10 and the slide cover 50 are several through holes 18, 52 serving as channels for adjustment and leaking out of sound pressure. In such a structure, the slide cover 50 can easily be combined with or separated from the ear hood unit 10. And, the slide cover 50 can be designed in various styles, including different colors, different size and shape of through hole 52, so the user can change them with ease. Especially, when the slide cover 50 having different positions or bore specifications of through hole 52 is changed, the user will enjoy much fun in listening to modified sound effects.

To sum up, the present invention using carefully planned and innovative structural design will not only improve on the shortcomings of conventional earphones having only two sound channels, but by the configuration design of front and rear speakers positioned on left and right, will also provide multiple channel sound recording which is quite popular nowadays, in addition to the effects of conventional two-way channels. With HRTF (Head-Related Transfer Function) or other sound effect treatment technology, it will further reinforce the space effect of acoustics, and create a more spacious audio sense to represent the surround sound field and dynamic effects in the recording, to enhance amusement and enjoyment when using the earphone to listen to or view a music recording or a film. Moreover, by changing the angles or positions of the ear hood unit, or replacement of the slide cover, the user can change the sound quality and sound field effects, to increase listening comfort. Compared with the conventional type of earphone products, the present invention is fully equipped with its inventive step, improvement and applicable efficiency; therefore this application is filed for a patent right. Your favorable consideration will be appreciated.

What is claimed is:

1. A surround sound effect earphone, comprising a front speaker and a rear speaker that are installed respectively at a front and a rear part inside a left and a right ear hood of a earphone set, said front and rear speaker are respectively connected to an independent signal cord before they are collectively connected to an earphone connector, inside an interior space of the ear hood and between the front and rear speakers being an appropriate space to accommodate a user's ears, so designed that when the earphone is worn at the user's ears, the front and rear speakers are located at a front and a rear side of the ears, providing front and rear surround sound effects.

2. The surround sound effect earphone of claim 1, wherein the ear hood unit can be separated into a front hood unit and a rear hood unit that can be combined, the front hood unit serving to accommodate the front speaker, the rear hood unit serving to accommodate the rear speaker, the front and rear hood units being respectively joined to a front a rear part of a support, the support being connected with a headband of the earphone, said front and rear hood units being capable of overturned using their joint as a spindle, thereby adjusting a distance and an angle of the front and rear speakers in relation to the user's ears.

3. The surround sound effect earphone of claim 1, wherein the ear hood unit is optionally designed to comprise a fixed front hood unit, and a rear hood unit that can slide and move in relation to the front hood unit, the front hood unit serving to fix the front speaker, the rear hood unit serving to fix the rear speaker, so by sliding the rear hood unit, the user can adjust the relative distance between the front and the rear speakers.

4. The surround sound effect earphone of claim 1, wherein the ear hood unit is optionally designed to include a detachable and combinable slide cover in the range of the rear speaker covered by a rear part of the hood unit, the front speaker being fixed at a front of the ear hood unit, the rear speaker being fixed at a rear of the ear hood unit, the slide cover being capable of sliding and moving between the ear hood units, or fastened by engaging a protruded fastener to a fastening hole, on the ear hood units and the slide cover being a plurality of through holes, the slide cover being designed in a plurality of different colors and different positions, sizes, or shapes of the through holes, for the purpose of replacement as the user pleases.
